(19) United States
(12) Patent Application Publication
(10) Pub. No.: US 2008/0102714 A1
(43) Pub. Date: May 1, 2008

(54) SERVICE SWITCHING DEVICE AND CONNECTION TERMINAL FOR A SERVICE SWITCHING DEVICE

(75) Inventors: Ralf WEBER, Heidelberg (DE); Klaus-Peter Eppe, Waldbrunn (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/925,288

(22) Filed: Oct. 26, 2007

(30) Foreign Application Priority Data
Oct. 28, 2006 (DE) 10 2006 050 933.1
Aug. 30, 2007 (DE) 10 2007 041 249.7

(51) Int. Cl. H01R 4/38

(52) U.S. Cl. 439/813

(57) ABSTRACT

A connection terminal is disclosed for installation in the terminal accommodating area of a service switching device, having a clamping screw, which has an actuating end and a clamping end opposite the actuating end, and having a terminal body, in which a clamping area is formed which is delimited by a web of the terminal body and in which a busbar and/or a connecting conductor can be pressed against a conductor bar by the clamping screw. A plug-type sleeve with a plug-in opening formed between two limbs for accommodating a connection lug of a busbar is fastened to the web of the terminal body outside the clamping area.

### CROSS REFERENCE TO RELATED APPLICATIONS

The present application claims priority under 35 U.S.C. §119 to German Application Nos. 10 2006 050 933.1 filed Oct. 28, 2006, and 10 2007 041 249.7 filed Aug. 30, 2007, the contents of which are hereby incorporated by reference in their entirety.

### BACKGROUND

1. Field

A service switching device having a housing and a connection terminal which is located in a terminal accommodating area of the housing is disclosed.

2. Background Information

A connection terminal has been used for screwing individual connecting conductors to a service switching device. In addition, it has also been used for fastening strip-shaped phase rails with their connection lugs electrically conductively to the service switching device.

Service switching devices are, for example, line circuit breakers, residual current circuit breakers or motor circuit breakers. With these service switching devices, a current path is guided through the interior of the service switching device between at least one incoming terminal and at least one outgoing terminal, the current path passing through further assemblies, in particular thermal and/or electromagnetic tripping assemblies and at least one contact point comprising a fixed contact piece and a movable contact piece.

DE 44 36 780 C2 discloses a service switching device having a connection terminal, in which the strip-shaped phase rail, possibly with its connection lug, is screwed to the narrow side of the service switching device, in a slot.

A further service switching device with a connection terminal is disclosed in EP 809 325 B1. Therein, the terminal connection area is split into a first connection area for the wire-shaped connecting conductor and a second connection area for the connection lug of the strip-shaped phase rail by means of a conductor bar.

The screw connection of the phase rails in known service switching devices can be complex since, when installing switching devices, for example in a distribution box, the fitter involves both hands to connect the device to the phase rails. With one hand the user holds the phase rail, and with the other hand the user actuates the screwdriver.

### SUMMARY

A service switching device and a connection terminal for a service switching device with a connection to phase rails are disclosed.

An exemplary embodiment of a service switching device disclosed herein comprises a housing; a connection terminal which is located in a terminal accommodating area of the housing; a clamping screw, which is accessible from a face side, having an actuating end and a clamping end opposite said actuating end; a terminal body, in which a clamping area is formed which is accessible from an adjacent narrow side wall via a first housing opening and is delimited on a side facing away from the clamping end by a web of the terminal body; and a plug-type sleeve, with a plug-in opening formed between two limbs for accommodating a connection lug of a busbar, fastened to the web of the terminal body outside the clamping area.

An exemplary connection terminal for installation in the accommodating area of a service switching device, comprises: a clamping screw, which has an actuating end and a clamping end opposite said actuating end; a terminal body, in which a clamping area is formed which is delimited by a web of the terminal body; and a plug-type sleeve, with a plug-in opening formed between two limbs for accommodating a connection lug of a busbar, fastened to the web of the terminal body outside the clamping area.

### BRIEF DESCRIPTION OF THE DRAWINGS

Exemplary embodiments and further advantageous configurations and improvements will be explained and described in more detail with reference to the drawings, in which exemplary embodiments are illustrated and in which:

FIG. 1 shows, schematically, a partial section through a first exemplary embodiment of a connection terminal as disclosed herein;

FIG. 2 shows, schematically, an exemplary side view of the connection terminal shown in FIG. 1;

FIG. 3 shows, schematically, a partial section through a second exemplary embodiment of a connection terminal as disclosed herein;

FIG. 4 shows, schematically, a partial section through a third exemplary embodiment of a connection terminal as disclosed herein;

FIG. 5 shows, schematically, an exemplary side view of the connection terminal shown in FIG. 4; and

FIG. 6 shows, schematically, a partial section through a fourth exemplary embodiment of a connection terminals as disclosed herein.

Identical or functionally identical components or elements have each been provided with the same reference numerals in the figures, even if they have a slightly modified form in various embodiments.

### DETAILED DESCRIPTION

According to an exemplary embodiment disclosed herein, a plug-type sleeve with a plug-in opening formed between two limbs for accommodating a connection lug of a busbar is fastened to the web of a terminal body outside the clamping area. As a result, a phase rail can be connected to the connection terminal by means of a screwless plug-type connection, which can be implemented by the fitter using one hand. The insertion of the phase rails can be easy and quick.

In accordance with an exemplary embodiment, the clamping area and the plug-in opening are arranged one behind the other, when viewed from a face side, and are accessible from the narrow side wall adjacent to a face side.

The clamping area and the plug-in opening can be arranged such that, when the service switching device is installed in a distribution box, the busbar can be fastened in the plug-type sleeve via a screwless clamping technique and the connecting conductor(s) can be fastened in the clamping area via a screw-clamping connection.

An exemplary embodiment can include a busbar and/or a connecting conductor pressed against a conductor bar by means of the clamping screw in the clamping area. The conductor bar may be a separate component which, for example, bears flat against the web of the terminal body and is connected to the web or is even integrally formed on the web. The conductor bar can serve for producing an electrical connection between the connection terminal and further assemblies or components of the service switching device. In particular, further conductors can be fastened to the conductor bar which guide the current path through the service switching device and which, in the process, make contact with other assemblies such as the contact point and a thermal or electromagnetic release.

An exemplary embodiment can include a busbar and/or a connecting conductor that can be pressed directly against the web of the terminal body by means of the clamping screw in the clamping area. The conductor bar can then be formed integrally on the web.

In accordance with a further embodiment, the plug-type sleeve can have a U shape, which is open in the “making” direction and whose limbs run in this direction and at right angles to the movement direction of the clamping screw, with the result that they surround the connection lug of the busbar on both sides. In this case, the plug-type sleeve can be a flat spiral spring bent in the form of a U, whose opening points in the direction of the connection lug of the busbar.

As regards the production of a connection terminal, an exemplary embodiment provides that the terminal body has approximately the form of a rectangular frame, having a web forming the first narrow side and limbs adjoining the web and forming two longitudinal sides, the free end of each limb being bent approximately at right angles towards the free end of the respective other limb, so that the bent free ends overlap one another and, as a result, form a second narrow side of the frame. In this case, the second narrow side can have an opening having a screw thread for accommodating and guiding the clamping screw.

The terminal body can be produced as a stamped bent part. The developed form of the terminal body with the limbs, the web and/or with the conductor bar integrally formed on the web can be stamped out of a metal sheet. Then, the limbs and/or the conductor bar can be bent back at correspondingly provided bending edges, so that finally a desired shape of the terminal body is produced.

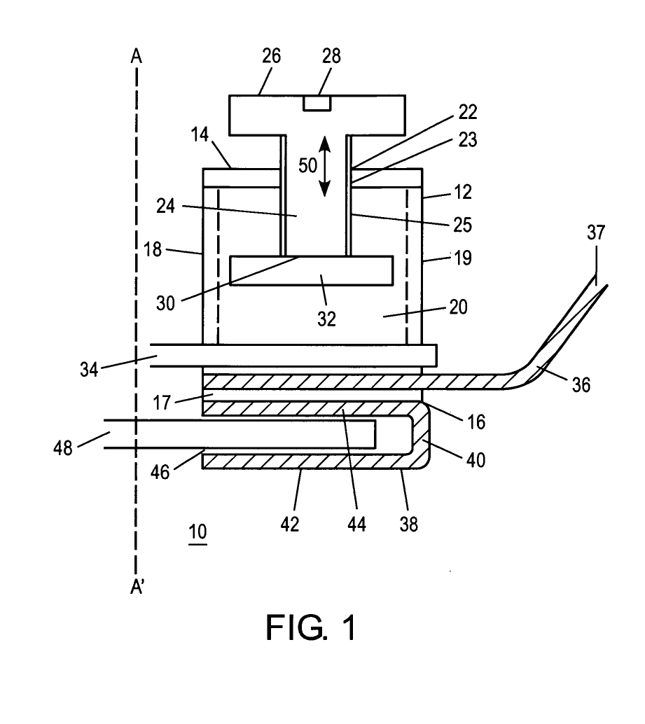

FIG. 1 shows a connection terminal 10 for installation in the terminal accommodating area of a service switching device, for example a line circuit breaker. The line circuit breaker itself is not illustrated.

The connection terminal 10 comprises a terminal body 12, which has approximately the shape of a rectangular frame. It has an upper narrow side 14 and a lower narrow side 16, which are connected by longitudinal sides 18, 19 lying parallel therebetween. The upper and lower narrow sides 14, 16 and the longitudinal sides 18, 19 delimit the clamping area 20.

The upper narrow side 14 has an opening 22, through which a clamping screw 24 protrudes into the clamping area 20. The clamping screw 24 has an actuating end 26 in the form of a screw head having a slot 28 for the engagement of a screwdriver. At the clamping end 30 opposite the screw head, the clamping screw 24 is connected to a pressure plate 32. The pressure plate 32 simplifies and can improve the mechanical and electrical contact between the clamping screw 24 and a connecting conductor 34 which can be inserted into the clamping area.

Instead of the head screw shown, it is also possible for a headless setscrew or any other type of screw to be used.

The opening 22 is provided with an internal thread 23, which interacts with the external thread 25 on the screw shaft of the clamping screw 24.

The clamping screw 24 can be screwed into the clamping area 20 by means of the thread 23, 25 in the direction of the arrow 50 or screwed out of the clamping area.

The lower narrow side 16 is formed by a web 17. A conductor bar 36 is fitted to the web 17; in the example illustrated here, it bears flat against the web 17 and is connected to it in an interlocking manner. The conductor bar 36 leads with its outgoing end 37 into the interior of the switching device, where it produces the electrical connection to functional assemblies of the service switching device, for example the release assemblies or the contact points, with other connecting conductors.

A plug-type sleeve 38 is fastened to the web 17 of the terminal body 12 outside the clamping area 20. The plug-type sleeve 38 can have approximately the form of a U and can comprise two limbs 42, 44 connected by a web 40. The plug-in opening 46 points outwards in the direction from which the connecting conductor 34 or a phase rail 48 or a busbar 48 with its connection lug are intended to be inserted into the terminal. The clamping area 20 and the plug-in opening 46 of the plug-type sleeve 38 can therefore be arranged one behind the other in relation to the movement direction 50 of the clamping screw 24 and can be accessible from a common access plane, the plane A-A′ parallel to the left-hand longitudinal side 18 in FIG. 1.

The two limbs 42, 44 of the plug-type sleeve 38 surround a busbar 48, which is plugged into the plug-type sleeve 38, on both sides. The plug-type sleeve shown in FIG. 1 is in this case, for example, a flat spiral spring which is bent in the form of a U and whose opening 46 points in the direction of the connection lug of the busbar 48. Owing to the spring force of the two limbs 42, 44, which acts on the inserted busbar 48 on both sides, good electrical contact between the busbar 48 and the limbs 42, 44 of the plug-type sleeve 38 can be provided.

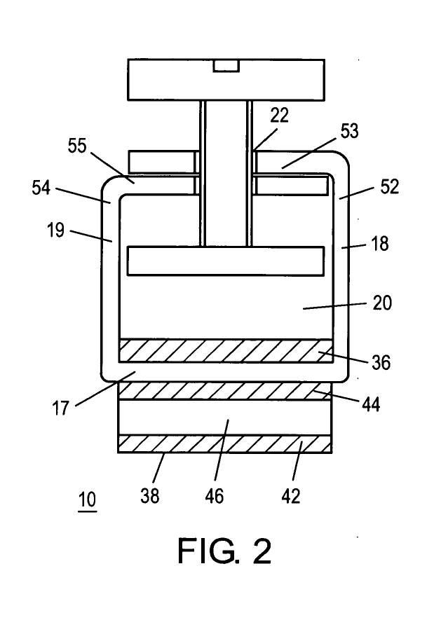

For improved clarity, FIG. 2 shows a view from the direction of the access plane AA′. This figure shows that two limbs 52, 54 forming the two longitudinal sides 18, 19 adjoin the web 17, which delimits the clamping area 20 at the bottom. The free ends 53, 55 of the two limbs 52, 54 can be in each case bent approximately at right angles towards one another and overlap one another. The upper narrow side 14 of the terminal body 12 is formed by the overlap between the limb ends 53, 55. In this embodiment, the terminal body 12 can be produced in a very simple and cost-effective manner as a stamped bent part. Its developed form in the plane is stamped out, and then the longitudinal sides 18, 19 are formed by the corresponding limbs 52, 54 being folded upwards and then the upper narrow side 14 is formed by the free ends 53, 55 of the limbs 52, 54 being folded back at right angles and overlapping one another.

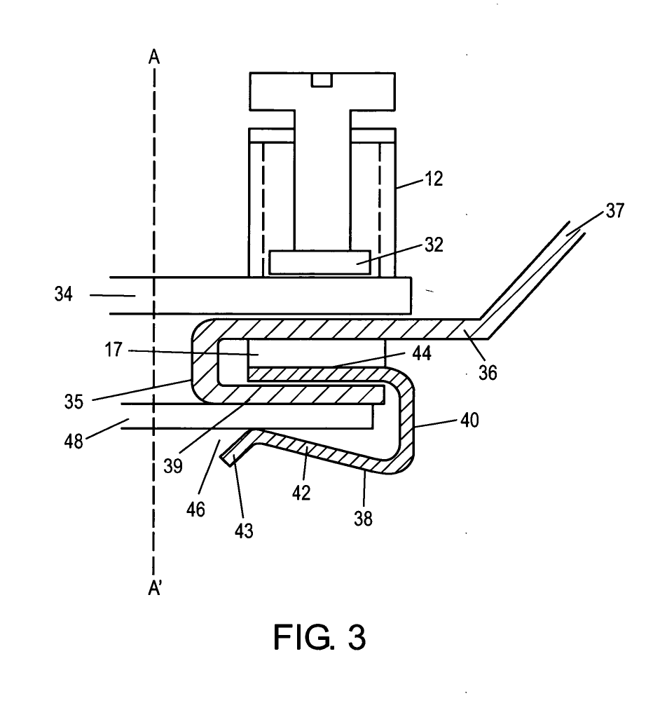

FIG. 3 shows a further embodiment. Here, the conductor bar 36, which is fitted to the web 17, is extended beyond the web 17 in the direction of the access plane AA′ and is bent back in the form of a U around the web 17. A bow-shaped conductor bar section 35, which protrudes in the direction of the access plane AA′, is therefore produced as well as a conductor bar limb 39, which runs parallel to the web 17 on its other side.

The plug-type sleeve 38 is fitted with its first limb 44 to that side of the web 17 which is opposite the conductor bar 36. The bow-shaped conductor bar section 35 and the conductor bar limb 39 of the conductor bar 36 fixedly clamp the first limb 44 of the plug-type sleeve to the web 17.

The web of the plug-type sleeve 38 runs downwards approximately parallel to the access plane AA′. The second limb 42 of the plug-type sleeve 38 then runs towards the first limb 44 at an angle and has a bent-up portion 43 at its free end. As a result, the plug-in opening 46 is in the form of a plug-in tulip contact.

The connection lug of the busbar 48 is inserted into the plug-type sleeve 38 between the edge formed by the second limb 42 and the bent-up portion 43 and the conductor bar limb 39 of the conductor bar 36. Owing to the spring force of the second limb 42 of the plug-type sleeve 38, the second limb presses the connection lug of the busbar 48 against the conductor bar limb 39 of the conductor bar 36 and therefore can produce safe mechanical and electrical contact.

A service switching device disclosed herein and having a connection terminal 10 can be inserted in a simplified manner into a distribution box, for example of a domestic installation. For example, the devices can be first fitted in a row next to one another in a known manner on a top-hat rail.

The common connection of devices lying next to one another by means of a phase rail can take place by means of the connection lugs of the phase rail being clamped on without the use of screws in the plug-type sleeves 38 of the connection terminals 10 of the service switching devices, which are arranged next to one another in a row.

The individual outgoing conductors of each individual switching device are then produced in a known manner by, for example, a screw connection. Since the phase rail, when viewed from the face side of the service switching device, is positioned behind the screw-clamping connection for the connecting conductor 34, the phase rail does not interfere when the connecting conductors are connected via the screw terminal.

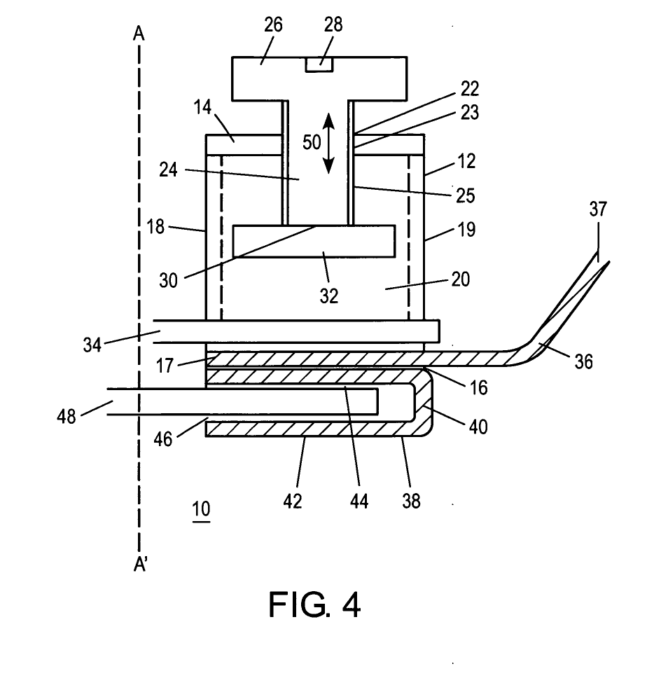

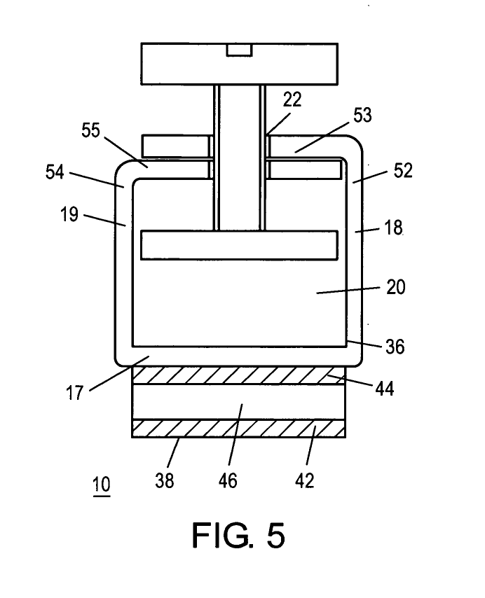

FIGS. 4 to 6 illustrate a third and fourth embodiments. A difference from the first and second embodiments shown in FIGS. 1 to 3 is that the clamping screw 24, with its pressure plate 32, presses the connecting conductor 34 directly against the web 17 forming the lower narrow side 16 of the terminal frame. The conductor bar 36 is integrally formed on the web 17 in the direction into the device interior.

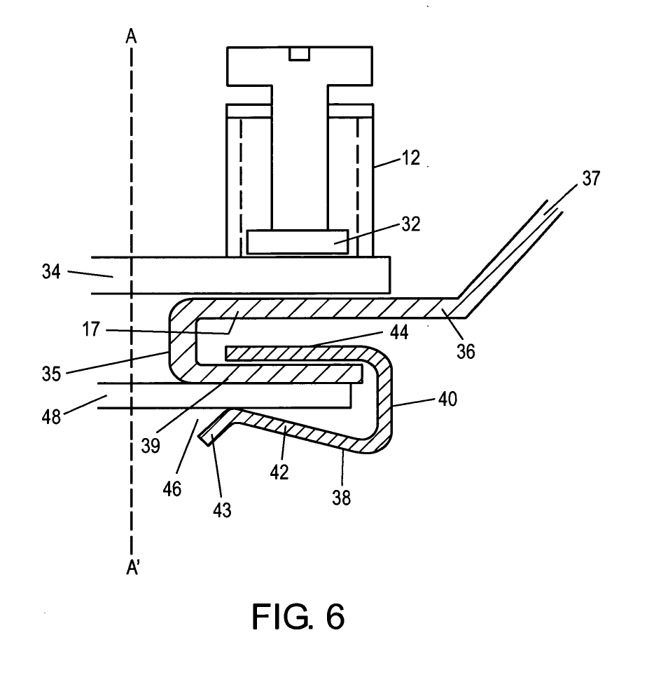

Consideration will now be given to FIG. 6. Here, the web 17 is extended in the direction of the access plane AA′ and bent back downwards in the form of a U. A bow-shaped conductor bar section 35, which protrudes in the direction of the access plane AA′, and a conductor bar limb 39, which runs parallel to the lower narrow side of the terminal body on its other side, are therefore produced.

The plug-type sleeve 38 is fitted with its first limb 44 to that side of the web 17 which is opposite the lower narrow side of the terminal body, for example is plugged on or pushed on. The bow-shaped conductor bar section 35 and the conductor bar limb 39 of the conductor bar 36 fixedly clamp the first limb 44 of the plug-type sleeve on the web 17.

The web 40 of the plug-type sleeve 38 runs downwards approximately parallel to the access plane AA′. The second limb 42 of the plug-type sleeve 38 then runs towards the first limb 44 at an angle and has a bent-up portion 43 at its free end. As a result, the plug-in opening 46 is in the form of a plug-in tulip contact.

The connection lug of the busbar 48 is inserted into the plug-type sleeve 38 between the edge formed by the second limb 42 and the bent-up portion 43 and the conductor bar limb 39 of the web 17. Owing to the spring force of the second limb 42 of the plug-type sleeve 38, the second limb presses the connection lug of the busbar 48 against the conductor bar limb 39 and therefore can produce safe mechanical and electrical contact.

The terminal body 12 shown in FIGS. 4 to 6 can be produced in a simple and cost-effective manner as a stamped bent part, corresponding to the description above relating to the embodiment shown in FIGS. 1 to 3. The conductor bar 36 is then, in the planar developed form of the terminal body 12, a further limb, which is also bent correspondingly when the terminal body is bent.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Reference Symbols

10 Connection terminal

12 Terminal body

14 Upper narrow side

16 Lower narrow side

17 Web

18, 19 Longitudinal sides

20 Clamping area

22 Opening

23 Internal thread

24 Clamping screw

25 External thread

26 Actuating end of clamping screw

28 Slot

30 Clamping end of clamping screw

32 Pressure plate

34 Connecting conductor

35 Bow-shaped conductor bar section

36 Conductor bar

37 Outgoing end of conductor bar

38 Plug-type sleeve

39 Conductor bar limb

40 Web of plug-type sleeve

42, 44 Limb of plug-type sleeve

43 Bent-up portion

46 Plug-in opening

48 Phase rails, busbar

50 Movement direction of clamping screw

52, 54 Limb of terminal body

53, 55 Free ends of limbs of terminal body

AA′ Access plane

We claim:

1. Service switching device comprising:
a housing;
a connection terminal which is located in a terminal accommodating area of the housing;
a clamping screw, which is accessible from a face side, having an actuating end and a clamping end opposite said actuating end;
a terminal body, in which a clamping area is formed which is accessible from an adjacent narrow side wall via a first housing opening and is delimited on a side facing away from the clamping end by a web of the terminal body; and
a plug-type sleeve, with a plug-in opening formed between two limbs for accommodating a connection lug of a busbar, fastened to the web of the terminal body outside the clamping area.

2. Service switching device according to claim 1, wherein the clamping area and the plug-in opening are arranged one behind the other, when viewed from the face side, and are accessible from the narrow side wall adjacent to the face side.

3. Service switching device according to claim 2, wherein the clamping area and the plug-in opening are arranged such that, when the service switching device is installed in a distribution box, the busbar can be fastened in the plug-type sleeve via a screwless clamping technique and a connecting conductor can be fastened in the clamping area via a screw-clamping connection.

4. Service switching device according to claim 1, wherein the busbar and/or a connecting conductor can be pressed against the web by the clamping screw in the clamping area.

5. Service switching device according to claim 1, wherein the busbar and/or a connecting conductor can be pressed against a conductor bar by the clamping screw in the clamping area.

6. Service switching device according to claim 5, wherein the conductor bar is formed integrally on the terminal body.

7. Service switching device according to claim 5, wherein the conductor bar bears flat against the web.

8. Connection terminal for installation in the terminal accommodating area of a service switching device, comprising:
a clamping screw, which has an actuating end and a clamping end opposite said actuating end;
a terminal body, in which a clamping area is formed which is delimited by a web of the terminal body; and
a plug-type sleeve, with a plug-in opening formed between two limbs for accommodating a connection lug of a busbar, fastened to the web of the terminal body outside the clamping area.

9. Connection terminal according to claim 8, wherein the clamping area and the plug-in opening are arranged one behind the other in relation to a movement direction of the clamping screw and are accessible from a common access plane (AA′).

10. Connection terminal according to claim 8, wherein the plug-type sleeve has a U shape, which is open in a “making” direction and whose limbs run in this direction and at right angles to a movement direction of the clamping screw, such that the plug-type sleeve surrounds the connection lug of the busbar on both sides.

11. Connection terminal according to claim 8, wherein the plug-type sleeve is a flat spiral spring bent to form a U, whose opening points in a direction of the connection lug of the busbar.

12. Connection terminal according to claim 8, wherein the terminal body has approximately a form of a rectangular frame, having a web forming the first narrow side and limbs adjoining said web and forming two longitudinal sides, a free end of each limb being bent approximately at right angles towards a free end of the respective other limb, so that the bent free ends overlap one another and, form a second narrow side of the frame.

13. Connection terminal according to claim 12, wherein a conductor bar is integrally formed on the web.

14. Connection terminal according to claim 12, wherein the second narrow side has an opening having a screw thread for accommodating and guiding the clamping screw.

15. Connection terminal installed in a service switching device, according to claim 8, wherein a connecting conductor can be fixedly clamped in the clamping area positioned between the clamping screw and the web, and the connection lug of the busbar can be fixedly clamped in the plug-type sleeve, which is fitted, when viewed from a face side of the service switching device, behind the web on the terminal body.

16. Service switching device according to claim 3, wherein the busbar and/or the connecting conductor can be pressed against the web by the clamping screw in the clamping area.

17. Connection terminal according to claim 9, wherein the plug-type sleeve has a U shape, which is open in a “making” direction and whose limbs run in this direction and at right angles to the movement direction of the clamping screw, such that the plug-type sleeve surrounds the connection lug of the busbar on both sides.

18. Connection terminal according to claim 17, wherein the plug-type sleeve is a flat spiral spring bent to form a U, whose opening points in a direction of the connection lug of the busbar.

19. Connection terminal according to claim 18, wherein the terminal body has approximately a form of a rectangular frame, having a web forming the first narrow side and limbs adjoining the web and forming two longitudinal sides, a free end of each limb being bent approximately at right angles towards a free end of the respective other limb, so that the bent free ends overlap one another and form a second narrow side of the frame.

20. Connection terminal according to claim 19, installed in a line circuit breaker, wherein a connecting conductor can be fixedly clamped in the clamping area positioned between the clamping screw and the web, and the connection lug of the busbar can be fixedly clamped in the plug-type sleeve, which is fitted, when viewed from a face side of the service switching device, behind the web on the terminal body.
